(19) United States
(12) Patent Application Publication
(10) Pub. No.: US 2025/0371548 A1
(43) Pub. Date: Dec. 4, 2025

(54) DETECTING FRAUDULENT DATA RECORDS WITH CONTRASTIVE LEARNING SEQUENCE MODELS

(71) Applicant: Stripe, Inc., South San Francisco, CA (US)

(72) Inventors: Chiranth Hegde, South San Francisco, CA (US); Yashu Lingaraju, South San Francisco, CA (US)

(21) Appl. No.: 18/679,354

(22) Filed: May 30, 2024

(51) Int. Cl. G06Q 20/40; G06Q 20/38

(52) U.S. Cl. CPC G06Q 20/4016; G06Q 20/389

(57) ABSTRACT

Discussed herein are methods and systems to train customized machine learning models in a more efficient manner (e.g., using fewer labeled data points). In one example, a method may include using a first machine learning to generate likelihoods of fraudulent activity for an aggregated series of data associated with a series of computing systems. Based on the calculated likelihoods, a server can generate a training dataset that includes fraudulent data associated with a first computing system, fraudulent data associated with any other computing system within the series of computing systems other than the first computing system, non-fraudulent data associated with the first computing system, and non-fraudulent data associated with any other computing system within the series of computing systems other than the first computing system. The server may then train a second machine learning model using the training data, e.g., using a contrastive learning method.

### TECHNICAL FIELD

This application relates generally to methods and systems for customized training of machine learning models using contrastive learning techniques to predict fraudulent electronic transactions.

### BACKGROUND

The rapid proliferation of advanced computing and digital technologies has led to the development of complex systems that involve interactions between various machine learning models, applications, and data sources. Such systems can be utilized in the field of fraud detection, particularly in monitoring electronic transactions. For example, a system may use a machine learning model to analyze transactions across different electronic platforms and computing systems. The machine learning models may be trained to identify patterns indicative of fraudulent activity by evaluating various transaction attributes such as amount, location, and timing. Given the evolving tactics of fraud and the limited adaptability of machine learning approaches, machine learning models may not always directly detect new or sophisticated fraud schemes. Accordingly, the system may incorporate additional data sources or analytical methods to improve the detection capabilities of the machine learning models.

### SUMMARY

In order to identify fraudulent activity, many existing computing infrastructures use machine learning models. However, conventional machine learning models trained using conventional methods face numerous technical challenges. Systems and methods using machine learning models for detecting fraudulent transactions rely on pre-defined workflows to access data from a single electronic data source and generate reports on potentially fraudulent activity within computing systems. These machine-learning models lack flexibility and may not adapt well to evolving fraud patterns or specific user needs. For example, a static workflow may not dynamically select the most relevant data sources or features based on the specific characteristics of a suspicious transaction. This approach, while providing a general assessment, fails to determine the complexities and evolving patterns of such attacks. For instance, by focusing solely on individual transactions, the machine learning models miss contextual insights that can be gleaned from analyzing sequences of transactions associated with a specific computing system. This limitation can result in inefficiencies as the machine learning models may not be optimized to gather the most relevant information for every potential fraud scenario.

Additionally, the challenges of using supervised learning techniques to train machine learning models can be exacerbated due to the difficulty of acquiring labeled data. For example, unlike supervised learning tasks where labeled examples are readily available, identifying instances of fraudulent transactions may lack explicit labels signifying fraud. This makes it challenging to build a sufficiently large and diverse dataset with accurately labeled fraudulent transaction instances. Additionally, the dynamic and evolving nature of fraud patterns may require constant updates to the labeled dataset, which can be time-consuming and resource-intensive. Moreover, the lack of labels for new or emerging fraud patterns further complicates the use of traditional supervised learning techniques. Therefore, using conventional supervised training methods faces technical challenges and is not desirable.

Furthermore, unsupervised learning techniques also encounter technical challenges when applied to detecting fraudulent activity due to the inherent nature of unsupervised learning algorithms. For example, unlike supervised learning techniques, where labeled examples guide the machine learning model, unsupervised learning techniques rely on the inherent structure of the input data to identify patterns and anomalies. In the case of fraudulent transaction detection, the lack of labeled data makes it difficult for unsupervised learning algorithms to accurately differentiate between legitimate and fraudulent transactions. Without explicit labels, the unsupervised learning algorithms may struggle to distinguish between normal variations in transaction behavior and fraudulent patterns.

Moreover, unsupervised learning algorithms often require a vast amount of unlabeled data to effectively capture the underlying data structure. In the context of fraudulent transaction detection, acquiring a sufficiently large and diverse dataset of unlabeled transactions can be challenging, especially considering the dynamic nature of fraud patterns. Additionally, unsupervised learning algorithms may struggle to generalize well to unseen fraudulent patterns. Since unsupervised learning algorithms rely solely on the input data's distribution to identify anomalies, they may not adapt well to new or evolving fraud techniques. Therefore, it is desirable to have a more dynamic configuration that can perform fraudulent transaction detection using contrastive learning sequence models.

The technical solutions described herein can incorporate a sequence-based contrastive learning model within a fraudulent transaction detection system to dynamically manage and process transaction data across multiple computing systems. In this regard, the fraudulent transaction detection system can integrate multiple computer models, where a first computer model can be trained on transaction data collected from various computing systems. The training of the first computer model can help identify fraud patterns without relying on labeled data indicating fraudulence. By using contrastive learning techniques (such as Triplet Loss, Quadruplet Loss, or Info NCE loss functions), the first computer model can be trained to identify potential fraud patterns based on positive and negative examples. The technical solution can enable the first computer model to differentiate between legitimate and fraudulent patterns based on the sequence and context of transactions. Using the methods and systems discussed herein, a machine-learning model can be trained using a smaller dataset than required by conventional methods. Therefore, the methods and systems discussed herein allow for more efficient training of machine learning models (e.g., using less data and training the model using less computing resources and in less time).

Additionally, a second computer model (e.g., an existing fraud model) can be used to further enhance the training process of the first computer model. The second computer model can be trained on a separate, smaller set of transactions. This information can then be fed to the first computer model for training purposes. For example, the second computer model can prioritize informative transaction sequences for the training of the first computer model. By focusing on sequences exhibiting characteristics commonly associated with fraudulent and legitimate transactions, the first computer model can improve its learning process and become more adept at identifying fraudulent patterns. Therefore, the methods and systems discussed herein can use one machine learning model (e.g., an existing fraud model) to train a new model. This allows for computational efficiency as the existing model may already be trained and does not need to be revised. Moreover, the methods and systems discussed herein allow for retrofitting existing computing infrastructure without the need to revise existing models, which is highly undesirable.

A machine learning model trained using the methods and systems discussed herein can be trained and customized to detect a specific type of fraud, as opposed to generic or conventional fraud. As fraudsters improve their knowledge and skill in cyber security attacks, they invent new fraud schemes that are hard to detect using conventional fraud models. For instance, many fraudsters use card testing schemes. Card testing is an emerging type of fraud where fraudsters use stolen or randomly generated credit card numbers to make small transactions, typically for a very low amount (e.g., a dollar), to verify if the card is active and can be used for larger transactions. If the small charge is successful, indicating that the card is valid, the fraudster will proceed to make larger fraudulent purchases. This process helps fraudsters identify working card numbers from a bulk list of stolen or generated ones. Card testing often involves automated scripts or bots that can quickly test large volumes of card numbers through online payment gateways.

These new fraud models are hard to detect using conventional fraud models because they are usually an amount that goes unnoticed by the user (hence, there will be fewer labeled data) and will usually go unreported. Moreover, small transactions can blend in with legitimate activity, leading to insufficient labeled data for training. Fraudsters also adapt their methods, varying transaction patterns to evade detection and high-volume, low-frequency testing further complicates identification. Traditional models, which rely on static rules and delayed data processing, struggle with these subtle and sporadic patterns, especially across different computing systems.

Using the methods and systems discussed herein, the machine learning model can be trained specifically for card testing activity. Therefore, “fraud,” as used herein, may refer to card testing activity and not traditional fraudulent activity (e.g., overcharging a user).

In some embodiments, a method may include executing, by a processor, the second machine learning model using a set of transaction data to predict a likelihood indicating whether each transaction within the set of transaction data is fraudulent; adding, by the processor, a first subset and a second subset of the set of transaction data to the training dataset, wherein each transaction within the first subset and the second subset of the set of transaction data has a likelihood of being fraudulent by satisfying a first threshold, wherein each transaction within the first subset is associated with a first computing system of a plurality of computing systems, each transaction within the second subset is associated with any computing system of the plurality of computing systems other than the first computing system, and the first subset and the second subset of the set of transactions are not labeled for training; adding, by the processor, a third subset and a fourth subset of the set of transaction data to the training dataset, wherein each transaction within the third subset and the fourth subset of the set of transaction data has a likelihood of being fraudulent by satisfying a second threshold, wherein each transaction within the third subset is associated with the first computing system of the plurality of computing systems, each transaction within the fourth subset is associated with any computing system of the plurality of computing systems other than the first computing system and the third subset and the fourth subset of the set of transactions are not labeled for training; and training, by the processor, the first machine learning model using the training dataset, such that the first machine learning model is configured to receive a new transaction and predict a likelihood of the new transaction being fraudulent.

The first machine learning model may be trained using a quadruplet training technique. The method may include adding, by the processor to the training dataset, a fifth subset of the set of transaction data that includes a label indicating whether any transaction within the fifth subset of the set of transaction data is fraudulent. At least one transaction within the training dataset may include a lineage labeling attribute. The method may include eliminating, by the processor from the training dataset, any transaction data with a confidence score that does not satisfy a third threshold. The new transaction may be a pending transaction for an amount less than a price threshold. The first, second, third, and fourth subsets of the set of transaction data may be selected further based on a similar attribute with the new transaction. The first machine learning model may be trained using an unsupervised method and without using any labeling data associated with the training dataset.

In some embodiments, a system may comprise one or more processors configured to cause a second machine learning model, using a set of transaction data, to predict a likelihood indicating whether each transaction within the set of transaction data is fraudulent; add a first subset and a second subset of the set of transaction data to the training dataset, wherein each transaction within the first subset and the second subset of the set of transaction data has a likelihood of being fraudulent by satisfying a first threshold, wherein each transaction within the first subset is associated with a first computing system of a plurality of computing systems, each transaction within the second subset is associated with any computing system of the plurality of computing systems other than the first computing system, and the first subset and the second subset of the set of transactions are not labeled for training; add a third subset and a fourth subset of the set of transaction data to the training dataset, wherein each transaction within the third subset and the fourth subset of the set of transaction data has a likelihood of being fraudulent by satisfying a second threshold, wherein each transaction within the third subset is associated with the first computing system of the plurality of computing systems, each transaction within the fourth subset is associated with any computing system of the plurality of computing systems other than the first computing system and the third subset and the fourth subset of the set of transactions are not labeled for training; and train the first machine learning model using the training dataset, such that the first machine learning model is configured to receive a new transaction and predict a likelihood of the new transaction being fraudulent.

The first machine learning model may be trained using a quadruplet training technique. The one or more processors may be further configured to add, to the training dataset, a fifth subset of the set of transaction data that includes a label indicating whether any transaction within the fifth subset of the set of transaction data is fraudulent. At least one transaction within the training dataset may include a lineage labeling attribute. The one or more processors may be further configured to eliminate, from the training dataset, any transaction data with a confidence score that does not satisfy a third threshold. The new transaction may be a pending transaction for an amount less than a price threshold. The first, second, third, and fourth subsets of the set of transaction data may be selected further based on a similar attribute with the new transaction. The first machine learning model may be trained using an unsupervised method and without using any labeling data associated with the training dataset.

In yet another embodiment, a non-transitory machine-readable storage medium having computer-executable instructions stored thereon that, when executed by one or more processors, cause the one or more processors to cause a second machine learning model, using a set of transaction data, to predict a likelihood indicating whether each transaction within the set of transaction data is fraudulent; add a first subset and a second subset of the set of transaction data to the training dataset, wherein each transaction within the first subset and the second subset of the set of transaction data has a likelihood of being fraudulent by satisfying a first threshold, wherein each transaction within the first subset is associated with a first computing system of a plurality of computing systems, each transaction within the second subset is associated with any computing system of the plurality of computing systems other than the first computing system, and the first subset and the second subset of the set of transactions are not labeled for training; add a third subset and a fourth subset of the set of transaction data to the training dataset, wherein each transaction within the third subset and the fourth subset of the set of transaction data has a likelihood of being fraudulent by satisfying a second threshold, wherein each transaction within the third subset is associated with the first computing system of the plurality of computing systems, each transaction within the fourth subset is associated with any computing system of the plurality of computing systems other than the first computing system and the third subset and the fourth subset of the set of transactions are not labeled for training; and train the first machine learning model using the training dataset, such that the first machine learning model is configured to receive a new transaction and predict a likelihood of the new transaction being fraudulent.

The first machine learning model may be trained using a quadruplet training technique. The computer-executable instructions may further cause the one or more processors to add, to the training dataset, a fifth subset of the set of transaction data that includes a label indicating whether any transaction within the fifth subset of the set of transaction data is fraudulent. The computer-executable instructions may further cause the one or more processors to eliminate, from the training dataset, any transaction data with a confidence score that does not satisfy a third threshold.

It is to be understood that both the foregoing general description and the following detailed description are exemplary and explanatory and are intended to provide further explanation of the invention as claimed.

### BRIEF DESCRIPTION OF THE DRAWINGS

The accompanying drawings constitute a part of this specification and illustrate embodiments of the subject matter disclosed herein.

FIG. 1 illustrates a computing system for detecting fraudulent electronic transactions with contrastive learning sequence models, according to one or more embodiments.

FIG. 2 illustrates a flowchart depicting operational steps for detecting fraudulent transactions with contrastive learning sequence models, according to an embodiment.

FIG. 3 illustrates an implementation of a machine learning technique, according to an embodiment.

FIG. 4 illustrates a flowchart depicting operational steps for detecting fraudulent transactions with contrastive learning sequence models, according to an embodiment.

FIG. 5 illustrates a component diagram of a computing system suitable for use in the various implementations described herein, according to an embodiment.

### DETAILED DESCRIPTION

Reference will now be made to the illustrative embodiments illustrated in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one ordinarily skilled in the relevant art and having possession of this disclosure, are to be considered within the scope of the subject matter disclosed herein. The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

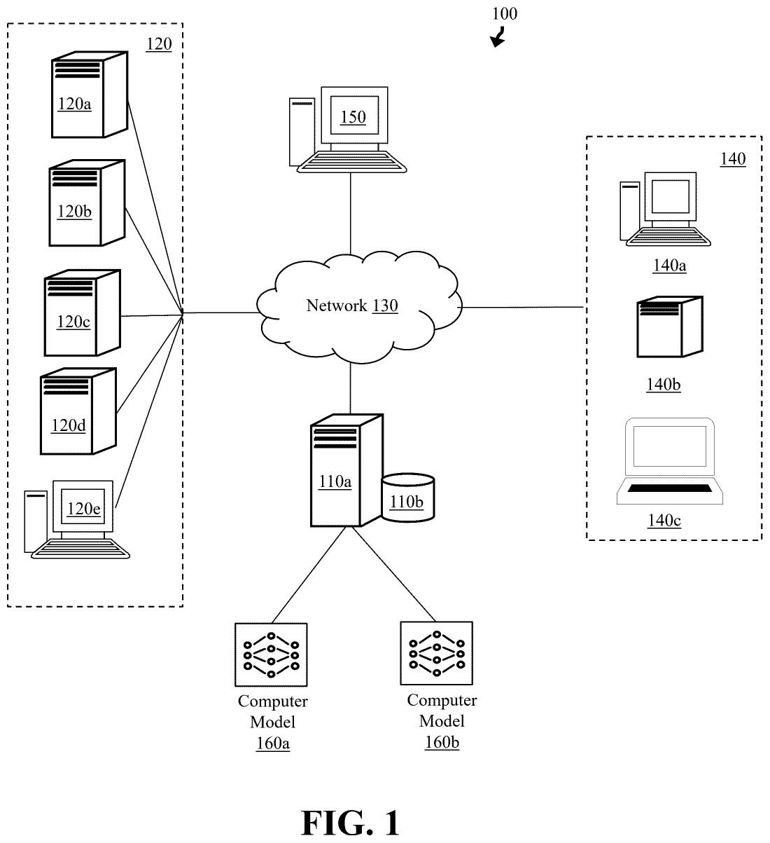

FIG. 1 is a non-limiting example of components of a fraudulent transaction detection system 100 in which an analytics server 110a operates. The analytics server 110a may utilize features described in FIG. 1 to process transaction data and predict the likelihood of a transaction being fraudulent.

The analytics server 110a may be communicatively coupled to a system database 110b, user devices 140a-c (collectively user devices 140), and an administrator computing device 150. The analytics server 110a may also use various computer models (e.g., the computer models 160a-b) to analyze the data. The computer model 160a-b can include one or more machine learning models. For example, a first computing model 160a can include a first machine learning model that can be trained using the data analyzed via the second computing model 160b.

In some embodiments, for convenience, the first computing model 160a can be referred to as the first machine learning model 160a, and the second computing model 160b can be referred to as the second machine learning model 160b. Moreover, even though the computer model 160b is depicted as a single model, it can be a collection of models itself.

The system 100 is not confined to the components described herein and may include additional or other components not shown for brevity, which are to be considered within the scope of the embodiments described herein. The system 100 may also include other servers (not depicted), which serve to conduct allowance or blocking of future transactions responsive to predictions generated by the first computer model 160a using the training dataset generated by the second computer model 160b.

The above-mentioned components may be connected to each other through a network 130. The examples of the network 130 may include, but are not limited to, private or public LAN, WLAN, MAN, WAN, and the Internet. The network 130 may include both wired and wireless communications according to one or more standards and/or via one or more transport mediums.

The communication over the network 130 may be performed in accordance with various communication protocols such as Transmission Control Protocol and Internet Protocol (TCP/IP), User Datagram Protocol (UDP), and IEEE communication protocols. In one example, the network 130 may include wireless communications according to Bluetooth specification sets or another standard or proprietary wireless communication protocol. In another example, the network 130 may also include communications over a cellular network, including, e.g., a GSM (Global System for Mobile Communications), CDMA (Code Division Multiple Access), and/or EDGE (Enhanced Data for Global Evolution) network.

The analytics server 110a may be configured to receive data (e.g., data associated with a transaction) from various sources and process the associated transaction data using a machine-learning model (e.g., the first computer model 160a) to predict the likelihood of fraud. The analytics server 110a may receive the data directly from a user (e.g., the user subscribed to the subscription service performing the transaction), an entity (e.g., a bank, credit card company, or credit bureau, among others) result, or from another processor (not shown) associated with an electronic payment system. In some embodiments, a user or a computing system (e.g., a merchant) and/or a system administrator (operating the administrator computing device 150) may use a platform (hosted by the analytics server 110a or a third party) to transmit the request to the analytics server 110. The platform may include one or more graphical user interfaces (GUIs) displayed on the user device 140 and/or the administrator computing device 150. For instance, the platform may include various GUIs that depict trends and statistical information regarding different computing systems and their respective fraudulent activities. For instance, the GUI may depict each merchant's number and trends associated with fraudulent activities.

An example of the platform generated and hosted by the analytics server 110a may be a web-based application or a website configured to be displayed on various electronic devices, such as mobile devices, tablets, personal computers, and the like. The platform may include various input elements configured to receive requests related to the transaction or the subscription service. For instance, a user may access the platform to initiate a transaction. Using the platform, the user may select the transaction to be processed and may provide a means of payment for the transaction.

The analytics server 110a may be any computing device comprising a processor and non-transitory, machine-readable storage capable of executing the various tasks and processes described herein. The analytics server 110a may employ various processors, such as a central processing unit (CPU) and graphics processing unit (GPU), among others. Non-limiting examples of such computing devices may include workstation computers, laptop computers, server computers, and the like. While the system 100 includes a single analytics server 110a, the analytics server 110a may include any number of computing devices operating in a distributed computing environment, such as a cloud environment.

The computer models 160 may represent a collection of various machine learning models or computer models that use algorithmic and/or artificial intelligence modeling techniques to process different transactions and, predict the likelihood of fraud, and train each other. In some embodiments, different computer models may be configured to determine different scores or thresholds using different methods and/or may be trained differently. For instance, the computer model 160a may be trained and calibrated to predict a transaction corresponding to a likelihood of being fraudulent (e.g., card testing), and the computer model 160b may be calibrated to determine a first score threshold corresponding to a score exceeding a predefined threshold or score.

In some embodiments, the computer model 160b can include one or more models, including, but not limited to, a real-time card testing day model (RTCTDM), a card testing day model (CTDM), a validation to payment (VTP), a decline model (DM), and a card testing transaction level CTTX model, among others. The RTCTDM can be used to identify and predict card testing transactions in real-time. The CTDM can be used to determine whether a computing system (e.g., merchant) is going through card testing on a specific day. The VTP model can be used to predict whether a transaction will result in a charge within 35 days (or any other time window). The DM can predict transactions that should be blocked to prevent fraudulent activity. The CTTX model can identify card-testing transactions and predict whether a transaction is part of a fraudulent (e.g., card testing) attack.

In some embodiments, the second machine learning model 160b can curate transaction data to be included within a training dataset by identifying relevant transaction data points and/or assigning scores or thresholds. The second machine learning model, 160b, can include one or more of the aforementioned machine learning models (e.g., RTCTDM, CTDM, VTP, CTTX, and/or DM).

In some implementations, the first machine learning model 160a can be trained using the data curated by the second machine learning model 160b to predict the likelihood of new transactions being fraudulent.

In some embodiments, a group of the computer models may belong to the same model. That is, in some embodiments, a single model may include various sub-models. Segmenting a single machine-learning model into different sub-models can be a powerful approach to tackling complex tasks, such as detecting fraud and determining metrics for the likelihood of a future transaction's success.

The electronic data sources used to generate the training dataset may be retrieved from various electronic data repositories (referred to herein as the electronic data sources 120). The electronic data sources 120 may include various merchant and electronic sources that store transaction data (including fraudulent transactions).

Computing systems 140 may be any computing device comprising a processor and a non-transitory, machine-readable storage medium capable of performing the various tasks and processes described herein. Non-limiting examples of the computing system 140 are a workstation computer, Point of Sale system, laptop computer, phone, tablet computer, and server computer. During operation, various users may use the computing systems 140 to conduct a transaction. Even though referred to herein as “user” devices, these devices may be operated by any party associated with a transaction, such as a merchant. For instance, a tablet 140c may be used by a computing system used on behalf of a merchant to conduct a sale. In another example, the computing systems 140 may include a point-of-sale terminal or a card reader.

The administrator computing device 150 may represent a computing device operated by a system administrator. The administrator computing device 150 may be configured to monitor various attributes generated by the analytics server 110a (e.g., a suitable service provider or various analytic metrics (e.g., the scores or thresholds) determined during training of one or more machine-learning models and/or systems); monitor one or more computer models 160 utilized by the analytics server 110a and/or user devices 140; review feedback; and/or oversee the electronic data sources 120 communicated with by the analytics server 110a.

In operation, the analytics server 110a may receive data associated with a future or new transaction, including a user identifier, a transaction amount, and a payment identifier. Using the methods discussed herein, the analytics server 110a may use the first machine learning model 160b to predict whether the new transaction is fraudulent. Based on the predictions, the analytics server 110a may train the first computer model 160a accordingly. The analytics server 110a may, upon determining that the transaction is fraudulent, instruct a second server to reject the transaction.

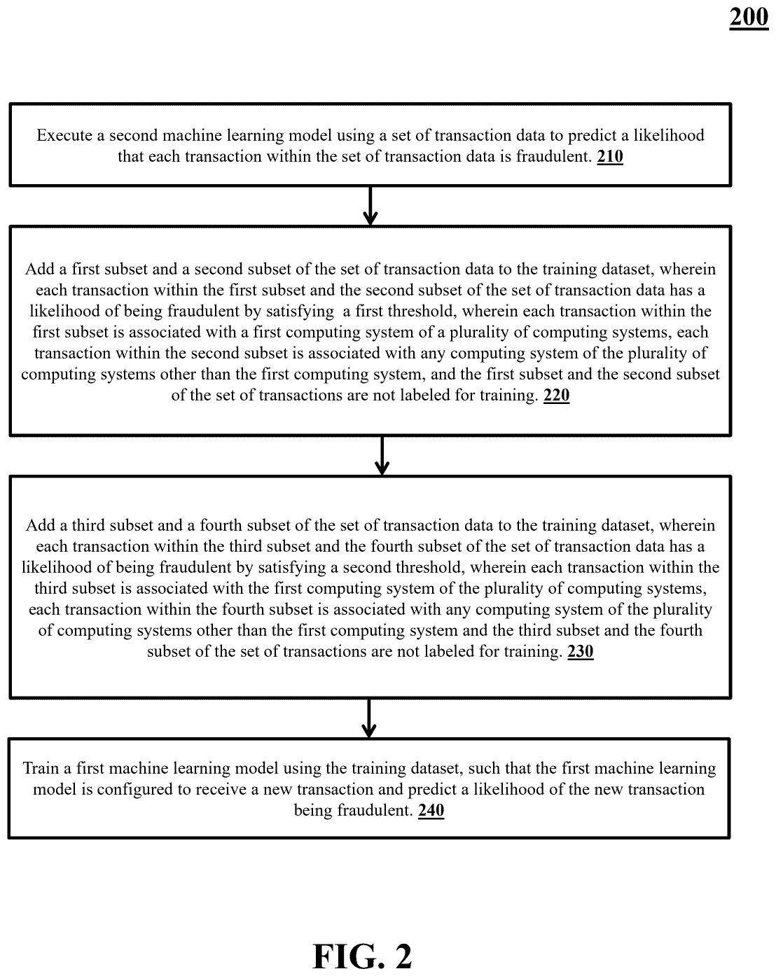

FIG. 2 illustrates a flow diagram of a process 200 executed by a fraudulent transaction detection system 100. The process 200 includes operations 210-240. However, other embodiments can include additional or alternative operations or can omit one or more operations altogether. The process 200 is described as being executed by a fraudulent transaction detection system that is the same as, or similar to, the fraudulent transaction detection system 100 described in FIG. 1. However, one or more operations of process 200 can also be executed by any number of computing devices operating in the distributed computing system described in FIG. 1. For instance, one or more computing devices (e.g., computing devices that can be the same as, or similar to, the analytics server) can perform some or all of the operations described in FIG. 2 alone or in cooperation with one or more other computing devices of FIG. 1. Using the methods and systems described herein, such as the process 200, the fraudulent transaction detection system 100 can identify fraudulent or legitimate transactions and can involve building sequential features from the transaction data, which are then analyzed by machine learning models for a determination of fraud likelihood.

At Step 210, the analytics server can retrieve a set of transaction data, which can come from various sources, such as a database of past transactions or a real-time feed of new transactions. Each transaction record can include details such as anonymized or hashed card details, computing system information including name and location, the transaction amount, date and time of the transaction, billing address, and other relevant details. In some implementations, the second machine learning model can be trained on a historical dataset, including label transactions (e.g., fraudulent and/or legitimate). The second machine learning model can identify fraudulent patterns within transaction data. In some implementations, the second machine learning model can process each transaction individually or in batches. The second machine learning model can process the transaction details, considering various factors that can be indicative of fraud, such as the transaction amount, location of the computing system, time of the transaction, billing address, and past transaction history associated with the card and computing system.

In some implementations, the second machine learning model can assign a score (e.g., a likelihood score) to each transaction. The likelihood score can represent the second machine learning model's prediction regarding the probability of the transaction being fraudulent. The scoring format can be a percentage value, a value on a specific scale, or any other meaningful measure where a higher score indicates a greater likelihood of fraud, according to the second machine learning model's assessment. In some implementations, the second machine learning model can generate a list of processed transactions, each with its corresponding likelihood score predicted by the second machine learning model.

At Step 220, the analytics server may add a first subset and a second subset of the set of transaction data to the training dataset, wherein each transaction within the first subset and the second subset of the set of transaction data has a likelihood of being fraudulent by satisfying a first threshold, wherein each transaction within the first subset is associated with a first computing system of a plurality of computing systems, each transaction within the second subset is associated with any computing system of the plurality of computing systems other than the first computing system, and the first subset and the second subset of the set of transactions are not labeled for training.

In some implementations, the first subset can be understood as a specific selection of transactions extracted from the larger dataset used in Step 210. In some implementations, the training dataset can serve as a collection of transaction data to train the first machine-learning model. In some implementations, the training dataset can serve as a collection of transaction data to train the second machine-learning model. Each record (e.g., individual transaction) within the first subset may not be labeled to indicate whether the transaction is fraudulent or legitimate. In some implementations, each record within the first subset may be labeled to indicate whether the transaction is fraudulent or legitimate.

In some implementations, each transaction within the first subset can indicate a likelihood of being fraudulent that satisfies a first threshold. For example, the score (likelihood score) of transactions that satisfy the first threshold exceeds a predefined threshold. The predefined threshold can be indicative of potential fraud. The first threshold can be a specific score (e.g., percentage or value on a scale). In some implementations, the first threshold can be predefined. In some implementations, the first threshold score can be generated by the second machine learning model. Additionally, each transaction within the first subset can be associated with a first computing system out of a plurality of computing systems. The first computing system can be interpreted as transactions that originated from the same computing system (e.g., merchant) in the context of card testing fraud.

Additionally, the analytics server may add a second subset of the set of transaction data to the training dataset. In some implementations, the second subset can be understood as a specific selection of a group of transactions for inclusion in the training data. Each record (e.g., individual transaction) within the second subset may not be labeled to indicate whether the transaction is fraudulent or legitimate. In some implementations, each record within the second subset may be labeled to indicate whether the transaction is fraudulent or legitimate.

The second machine learning model can select transactions for the second subset based on the likelihood of fraud. For example, in this instance, the score (likelihood score) can satisfy the first threshold, indicating that the score of transactions exceeds the predefined threshold. Each transaction within the second subset can be associated with a different computing system (merchant) compared to the first computing system. This means the transactions can originate from computing systems other than those used in the previous steps.

Effectively, in the step 220, the analytics server may add a first subset of the dataset analyzed in the step 210 that includes fraudulent transactions associated with the merchant and a second subset of the dataset analyzed in the step 210 that includes fraudulent transactions associated with different merchants.

At Step 230, the analytics server may add a third subset and a fourth subset of the set of transaction data to the training dataset, wherein each transaction within the third subset and the fourth subset of the set of transaction data has a likelihood of being fraudulent by satisfying a second threshold, wherein each transaction within the third subset is associated with the first computing system of the plurality of computing systems, each transaction within the fourth subset is associated with any computing system of the plurality of computing systems other than the first computing system and the third subset and the fourth subset of the set of transactions are not labeled for training.

In some implementations, the third subset can be understood as a specific selection of a group of transactions for inclusion in the training data. Each record (e.g., individual transaction) within the third subset may not be labeled to indicate whether the transaction is fraudulent or legitimate. In some implementations, each record within the third subset may be labeled to indicate whether the transaction is fraudulent or legitimate.

In some implementations, each transaction within the third subset can indicate a likelihood of being legitimate that satisfies a second threshold. For example, the score (likelihood score) of transactions that satisfy the second threshold falls below the predefined threshold. The second threshold can be a specific score (e.g., percentage or value on a scale). In some implementations, the second threshold can be predefined. In some implementations, the second threshold score can be generated by the second machine learning model. Additionally, each transaction within the third subset can be associated with the same computing system, meaning all transactions originated from the same computing system.

Additionally, the analytics server may add a fourth subset of the set of transaction data to the training dataset. In some implementations, the fourth subset can be understood as a specific selection of a group of transactions for inclusion in the training data. Each record (e.g., individual transaction) within the fourth subset may not be labeled to indicate whether the transaction is fraudulent or legitimate. In some implementations, each record within the fourth subset may be labeled to indicate whether the transaction is fraudulent or legitimate.

The second machine learning model can select transactions for the fourth subset based on the likelihood of fraud. For example, in this instance, the score (likelihood score) can satisfy the second threshold, indicating that the score of transactions falls below the predefined threshold. Each transaction within the fourth subset can be associated with a different computing system (merchant) compared to the first computing system. This means the transactions can originate from computing systems other than those used in the previous steps.

Effectively, in the step 230, the analytics server may add a third subset of the dataset analyzed in the step 210 that includes non-fraudulent transactions associated with the merchant and a fourth subset of the dataset analyzed in the step 210 that includes non-fraudulent transactions associated with different merchants.

At Step 240, the analytics server can train the first machine-learning model using the training dataset. The first machine learning model can be a new model being trained to detect card testing fraud. In some implementations, the processor can train the first machine-learning model using various methods, such as a quadruplet training technique. In some implementations, the training process can implement a quadruplet loss function to improve the first machine learning mode's ability to distinguish between similar and dissimilar transaction patterns. For example, as explained in previous steps, the training dataset can include data from various sources, including, transactions likely fraudulent from the same computing system, transactions likely legitimate from the same computing system, transactions likely fraudulent from different computing systems, and transactions likely legitimate from different computing systems.

By including the subsets of transactions discussed herein, steps 220-240, the analytics server may no longer need every data point (e.g., transaction) to be labeled. The analytics server may train the machine learning model using a semi-supervised manner. Because the training dataset is already curated and only includes a targeted group of transaction data, the training may be performed more efficiently (e.g., faster and using less computing power).

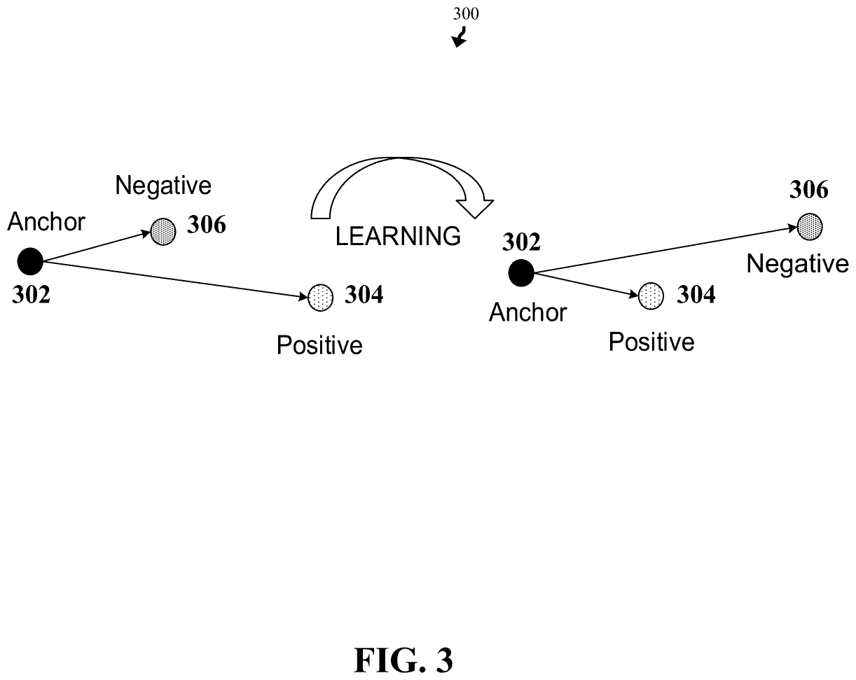

In some implementations, as shown in connection with FIG. 3, depicted is a machine learning technique 300 that can use a triplet loss function. The learning technique 300 can include an anchor point 302 (a specific transaction by a computing system (e.g., merchant)), a positive example 304 (another transaction by the same computing system with similar characteristics, such as occurring in a short time window and involving a small amount), and a negative example 306 (any other transactions that do not display these characteristics).

In this regard, the first machine learning model can learn how to compute the relative distances between the anchor point 302 and the positive example 304, as well as how to compute the relative distances between the anchor point 302 and the negative example 306. In some implementations, the first machine learning model can learn to push apart the clusters representing fraudulent transactions. For example, the first machine learning model can learn to create a wider gap between the clusters representing fraudulent and legitimate transactions. For instance, when a new transaction is processed, the first machine learning model can determine the location of the new transaction relative to the clusters. If the new transaction falls closer to a cluster of known fraudulent transactions, the first machine learning model can identify the new transaction as potentially fraudulent.

In some implementations, the first machine learning model can create a distinction based on proximity. For example, the first machine learning model can learn that the anchor point 302 may be closer to the positive example 304 than to the negative example 306, or vice versa. In some implementations, the first machine learning model can learn that the distance between similar examples may be smaller than the distance between dissimilar examples, or vice versa.

In some implementations, the first machine learning model can use the quadruplet loss function, as described above. For instance, the technique can build upon triplet loss by adding a second negative example: an intra-negative, which can be a transaction from the same computing system (or the same merchant class) but different from the anchor point 302 (e.g., a certain transaction from a computing system), and an inter-negative, which can be a transaction from a different computing system (or the different merchant class) and different from the anchor point 302. In some implementations, the first machine learning model can be trained to differentiate between fraudulent and legitimate transactions across various categories. For example, the first machine learning model can transform each transaction into a vector of numerical features that represent its characteristics.

In some implementations, the first machine learning model can determine the relationships between these features to differentiate between fraudulent and legitimate transactions. In some implementations, the first machine learning model can be trained to identify variations in fraudulent activities within transactions from the same computing system.

In some implementations, the first machine learning model can use an InfoNCE (Information Noise Contrastive Estimation) loss function. The InfoNCE loss function can formulate the training process as a classification problem. For example, in this regard, the first machine learning model's objective can be to correctly identify the positive pair (e.g., anchor point and its true match) from a set of candidate pairs that include both positive and negative examples.

In some implementations, a positive example 304 can be a transaction by the same computing system that exhibits similar characteristics suggestive of potential fraud, such as occurring within a short timeframe and/or involving a small amount (indicative of card testing). In some implementations, the positive example 304 can be a transaction from a different computing system with similar characteristics to the anchor point 302. In some implementations, a negative example 306 can be a transaction that lacks the suspicious characteristics associated with the positive example 304.

In some implementations, the quadruplet loss function can mathematically indicate the desired separation between the anchor point 302 and positive/negative examples 304 and 306 using a distance function and a margin. For example, the distance function can measure the similarity between two data points (transactions in this case). In some implementations, the distance function can include an Euclidean distance, which calculates the straight-line distance between two points in a multi-dimensional space, representing the transaction features. In some implementations, the distance function can include a cosine distance, which calculates the directional similarity between two vectors, indicating how closely the corresponding angles are aligned. The margin can be a hyperparameter that defines the minimum desired gap between the distances.

In some implementations, the margin can indicate the minimum desired gap between the distance between the anchor point 302 and the intra-negative example 306, and the distance between the anchor point 302 and the positive example 304. In some implementations, the margin can indicate the minimum desired gap between the distance between the anchor point 302 and the inter-negative example 306, and the distance between the anchor point 302 and the positive example 304. The first machine learning model can be trained to create a representation space where the anchor point 302 (e.g., potentially fraudulent transaction) is closer to its true match (e.g., positive example or similar transaction) and further away from both the intra-negative 306 and the intera-negative 306 by at least the specified or predefined margins.

In some implementations, the training process can be unsupervised, meaning the data in the training dataset may not be explicitly labeled as fraudulent or legitimate. The first machine learning model can learn patterns and relationships within the data to identify characteristics associated with card testing fraud. During the training process, the processor can feed the training dataset to the first machine-learning model. In some implementations, one or more transactions within the training dataset can include a lineage labeling attribute. The lineage labeling attribute can track the history or origin of a transaction. In some implementations, the lineage labeling attribute can be used to indicate a particular card's decline history within a specific timeframe (e.g., past year).

The first machine learning model can use a semi-supervised learning approach to process transaction data, including details such as transaction amount, location, computing system information, and likelihood scores, among others. In this regard, the second machine learning model can add a fifth subset (via the analytics server) of transaction data to the training dataset. The fifth subset can include labels indicating whether each transaction is fraudulent or legitimate. In some implementations, the labeled data within the fifth subset can be used for fine-tuning the first machine-learning model by adjusting the parameters to improve the ability of the first machine-learning model to distinguish fraudulent transactions based on the newly learned patterns in the labeled data.

In some implementations, the first machine learning model can iteratively refine its internal parameters based on the unlabeled data, attempting to identify patterns that differentiate between likely fraudulent and likely legitimate transactions. In some implementations, the training process can continue until the first machine learning model reaches a stopping criterion, such as achieving a desired level of accuracy on a separate validation dataset. In some implementations, after training, the first machine learning model can receive a new transaction as input, process the transaction details and historical data (if available), and predict a likelihood score indicating the probability of the new transaction being fraudulent.

In some implementations, the new transaction being processed can be a pending transaction with an amount less than a price threshold. For example, the new transaction being processed can be a low-value transaction. In some implementations, the amount can be less than a certain threshold (e.g., $5). In some implementations, the selection of transactions for the various subsets (Steps 220-250) may consider similar attributes between those transactions and the new transaction being processed (e.g., amount, category, location). These attributes can include factors such as transaction amount, computing system category, or location to focus the training data on situations relevant to the specific transaction being processed. For instance, if the new transaction involves a purchase from a grocery store, the first machine learning model can prioritize training data, including past transactions from similar computing systems or merchants (same category or class) or even nearby locations.

In some implementations, the second machine learning model can generate a confidence score for each transaction or a set of transaction data to assess the likelihood of the transaction being fraudulent. The confidence score can indicate how certain the second machine-learning model is in its determination, such that the data associated with the corresponding transaction may be added to the training dataset for the first machine-learning model. In some implementations, the analytics server can eliminate transaction data from the training dataset if the confidence score does not satisfy a predefined third threshold. For example, in a non-limiting example, the analytics server can remove a transaction with a confidence score of 60% from the training dataset if the threshold for inclusion in the training dataset is 90%.

Using the methods and systems discussed herein brings significant technical advantages to card testing detection by enabling real-time fraud identification through the use of sequential feature analysis and semi-supervised learning, which leverages both labeled and unlabeled data for improved accuracy. The incorporation of contrastive learning with a quadruplet loss function allows for precise differentiation between various transaction patterns, enhancing detection capabilities. Additionally, the adaptive modulation of risk thresholds based on real-time scores minimizes false positives and negatives, ensuring efficient fraud prevention without disrupting legitimate transactions. The machine learning model trained using the methods and systems discussed herein can be utilized for both small and large computing systems, providing a robust solution to evolving card testing fraud techniques.

Using the methods and systems allows for a significant technical advantage by enabling seamless retrofitting into existing payment processing infrastructures and utilizing current machine learning models. By leveraging the Real-Time Card Testing Daemon (RTC TDM) and integrating sequential feature analysis with semi-supervised learning, the new model enhances detection capabilities without requiring a complete overhaul of the existing system. Therefore, the methods and systems discussed herein allow the new system to quickly and efficiently augment the existing infrastructure, providing improved fraud detection capabilities while maintaining operational continuity.

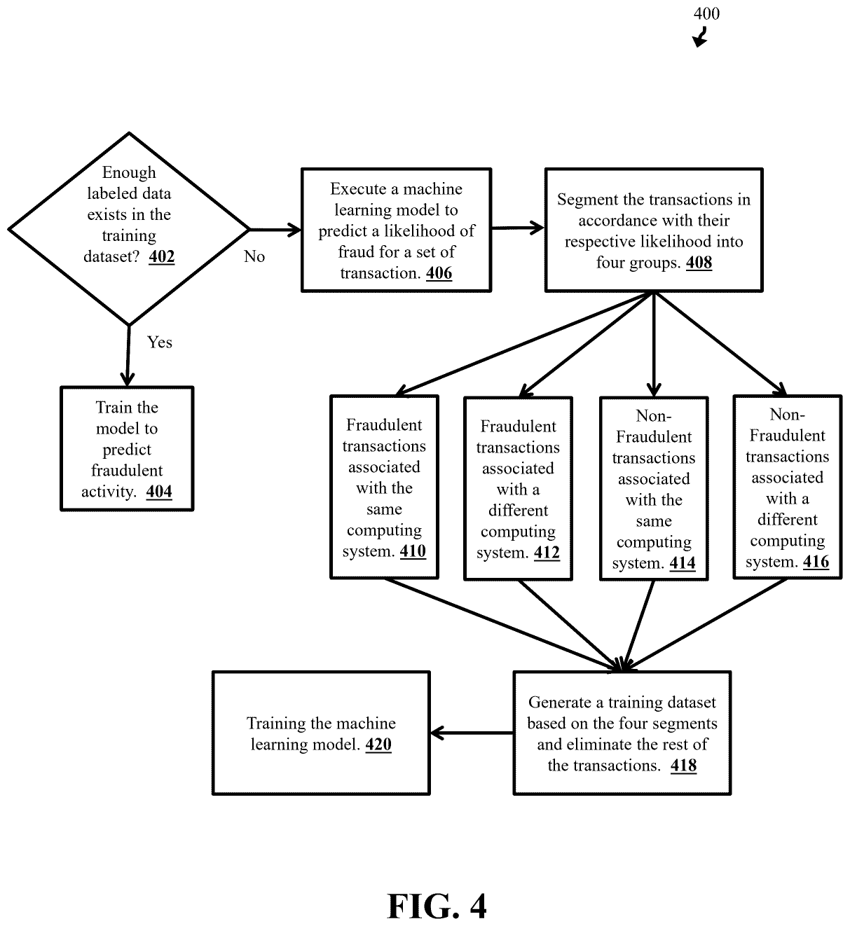

FIG. 4 illustrates a flow diagram of a process 400 executed by a fraudulent transaction detection system 100. The process 400 includes steps 402-420. However, other embodiments can include additional or alternative operations or can omit one or more operations altogether. The process 400 is described as being executed by a fraudulent transaction detection system that is the same as, or similar to, the fraudulent transaction detection system 100 described in FIG. 1. However, one or more operations of process 400 can also be executed by any number of computing devices operating in the distributed computing system described in FIG. 1. For instance, one or more computing devices (e.g., computing devices that can be the same as, or similar to, the analytics server) can perform some or all of the operations described in FIG. 4 alone or in cooperation with one or more other computing devices of FIG. 1.

The process 400 starts with step 402, in which a processor, such as the analytics server 110a discussed in FIG. 1, is tasked with training a machine learning model to identify/predict whether any new transaction corresponds to fraudulent activity. Specifically, the analytics server may receive a request to train a machine learning model to predict whether a transaction is a card testing transaction, which is a specific type of fraudulent activity.

In the step 402, the analytics server may determine whether enough labeled data exists to train the machine learning model (e.g., the first machine learning model in this example). As discussed herein, training and machine learning models to identify specific types of fraudulent activity are especially challenging due to a lack of labeled data. For instance, many card testing transactions go unnoticed until the main/actual fraud (e.g., a fraudulent transaction has been a much larger amount) is detected. Therefore, most electronic payment systems do not have enough labeled card testing data to train machine learning models to predict that specific occurrence. In the step 402, the analytics server may determine whether enough labeled data exists. If so (the “yes” branch), the analytics server may move to the step 404, whereby the analytics server trains the machine learning model using the label data to predict fraudulent activity.

However, if not enough labeled data exists (the “no” branch), the analytics server may move to the step 406. The analytics server may retrieve a large set of transactions associated with one or more computing systems. The large set of transactions may include aggregated transactions where some are fraudulent, and some are not fraudulent. For instance, the aggregated set of data may include a raw, unlabeled series of transactions associated with a card issuer and/or a particular electronic payment system.

The analytics server may then execute a machine learning model to predict the likelihood of fraud for the set of retrieved transactions. For instance, the analytics server may execute an RTCTDM, CTDM, VTP, DM, and/or a CTTX model in order to predict the likelihood of each transaction within the retrieved set of transactions belonging to fraudulent activity (card testing).

Using the likelihood discussed above, the analytics server may (at step 408) segment the transactions in accordance with their respective likelihood into four groups.

The first group may include fraudulent transactions associated with the same computing system. At the step 410, the analytics server may be requested to train the machine learning model such that the machine learning model is customized for a particular computing system or merchant. Using the likelihoods generated in the step 406, the analytics server may determine which transactions are likely fraudulent. To achieve this, the analytics server may use a threshold (e.g., 50% or more likelihood of fraud) to identify a subset of transactions that are likely fraudulent. The analytics server may then determine all likely transactions that belong to the same computing system (the same computing system used to train the machine learning model).

At the step 412, the analytics server may identify a subset of the transactions retrieved in step 406 that are likely fraudulent but belong to other computing systems. As used herein, other computing systems may be any computing system or merchant other than the merchant used in the step 410. In some embodiments, the other computing systems may be selected in accordance with a common attribute of the computing system used in the step 410. For instance, if the machine learning model is being trained for a merchant in Utah, then that particular merchant will be used to segment the transaction data in the step 410. However, the “other” merchants may be not selected at random. Instead, the “other” merchants may be selected from a group of merchants who are also in Utah.

The analytics server may use any attribute to select the “other” merchant. For instance, if the merchant for which the machine learning model is being trained for is a small merchant (1 million Dollars per year), then the “other” merchants will also be small merchants and may not include merchants that process more than a certain threshold per year (e.g., not more than 5 million Dollars per year).

At the step 414, the analytics may identify a subset of transactions retrieved in the step 406 that are likely not fraudulent (e.g., have a likelihood that is less than the threshold) and that belong to the same computing system as step 410.

At the step 416, the analytics server may identify a subset of transactions retrieved in the step 406 that are likely not fraudulent but belonged to a different computing system or merchant as the step 410.

After segmenting the retrieved transactions into four categories, the analytics server may (at step 418) generate a training dataset. The training dataset may include a defined number of transactions from each category discussed herein. For instance, if the retrieved number of transactions in the step 406 includes a thousand transactions, the training dataset may include merely 50 transactions per segment (e.g., 410-416). As a result, the training dataset curated by the analytics server may include fewer number of transactions. Using a fewer number of transactions allows the training to be performed at a more efficient rate than using conventional methods while achieving the same or better results.

At the step 420, the analytics server may train the machine learning model (e.g., the first machine learning model) using the training dataset. The transactions included within the training dataset may not be labeled as fraudulent or not fraudulent. Because the training dataset is curated, the training dataset may be unlabeled. Because labeling training datasets requires heavy computing power, and because using the methods and systems discussed herein does not require specific labeling, the machine learning model can be trained more efficiently.

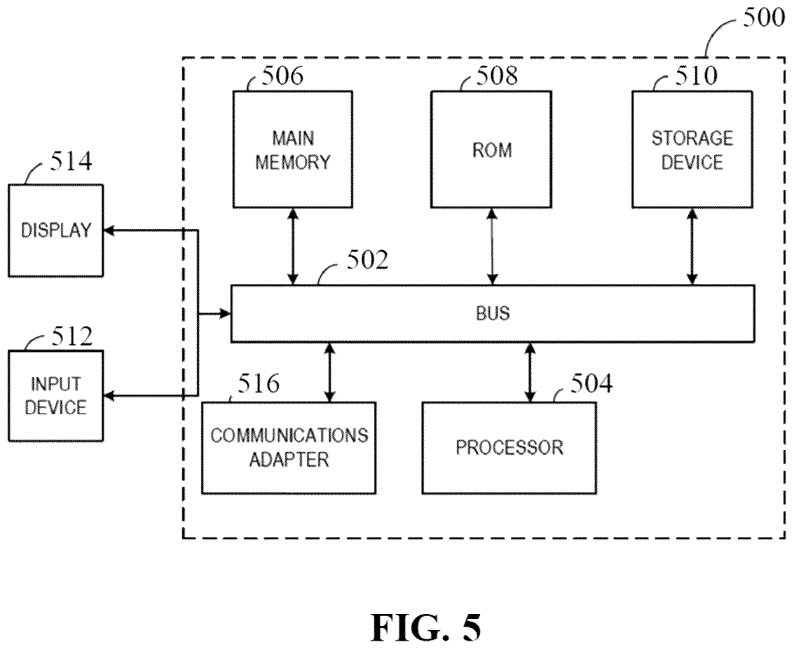

FIG. 5 is a component diagram of an example computing system suitable for use in the various implementations described herein, according to an example implementation. One or more steps of the methods and processes discussed herein can be performed by the computing system depicted in FIG. 5.

The computing system 500 includes a bus 502 or other communication component for communicating information and a processor 504 coupled to the bus 502 for processing information. The computing system 500 also includes a main memory 506, such as a RAM or other dynamic storage device, coupled to the bus 502 for storing information, and instructions to be executed by the processor 504. Main memory 506 can also be used for storing position information, temporary variables, or other intermediate information during execution of instructions by the processor 504. The computing system 500 may further include a ROM 508 or other static storage device coupled to the bus 502 for storing static information and instructions for the processor 504. A storage device 555, such as a solid-state device, magnetic disk, or optical disk, is coupled to the bus 502 for persistently storing information and instructions.

The computing system 500 may be coupled via the bus 502 to a display 514, such as a liquid crystal display, or active matrix display, for displaying information to a user. An input device 512, such as a keyboard including alphanumeric and other keys, may be coupled to the bus 502 for communicating information, and command selections to the processor 504. In another implementation, the input device 512 has a touch screen display. The input device 512 can include any type of biometric sensor, or a cursor control, such as a mouse, a trackball, or cursor direction keys, for communicating direction information and command selections to the processor 504 and for controlling cursor movement on the display 514.

In some implementations, the computing system 500 may include a communications adapter 516, such as a networking adapter. Communications adapter 516 may be coupled to bus 502 and may be configured to enable communications with a computing or communications network or other computing systems. In various illustrative implementations, any type of networking configuration may be achieved using communications adapter 516, such as wired (e.g., via Ethernet), wireless (e.g., via Wi-Fi, Bluetooth), satellite (e.g., via GPS) pre-configured, ad-hoc, LAN, WAN, and the like.

According to various implementations, the processes of the illustrative implementations that are described herein can be achieved by the computing system 500 in response to the processor 504 executing an implementation of instructions contained in main memory 506. Such instructions can be read into main memory 506 from another computer-readable medium, such as the storage device 510. Execution of the implementation of instructions contained in main memory 506 causes the computing system 500 to perform the illustrative processes described herein. One or more processors in a multi-processing implementation may also be employed to execute the instructions contained in the main memory 506. In alternative implementations, hard-wired circuitry may be used in place of or in combination with software instructions to implement illustrative implementations. Thus, implementations are not limited to any specific combination of hardware circuitry and software.

The foregoing method descriptions and the process flow diagrams are provided merely as illustrative examples and are not intended to require or imply that the steps of the various embodiments must be performed in the order presented. The steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, and the like. When a process corresponds to a function, the process termination may correspond to a return of the function to a calling function or a main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the generic principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

1. A method of accelerating training time for training a first machine learning model using a training dataset generated via a second machine learning model, the method comprising:
executing, by a processor, the second machine learning model using a set of network operation data to predict a likelihood indicating whether each network operation within the set of network operation data is fraudulent;
adding, by the processor, a first subset and a second subset of the set of network operation data to the training dataset,
wherein each network operation within the first subset and the second subset of the set of network operation data has a likelihood of being fraudulent by satisfying a first threshold,
wherein each network operation within the first subset is associated with a first computing system of a plurality of computing systems, each network operation within the second subset is associated with any computing system of the plurality of computing systems other than the first computing system, and the first subset and the second subset of the set of network operation are not labeled for training;
adding, by the processor, a third subset and a fourth subset of the set of network operation data to the training dataset, wherein each network operation within the third subset and the fourth subset of the set of network operation data has a likelihood of being fraudulent by satisfying a second threshold, wherein each network operation within the third subset is associated with the first computing system of the plurality of computing systems, each network operation within the fourth subset is associated with any computing system of the plurality of computing systems other than the first computing system and the third subset and the fourth subset of the set of network operation are not labeled for training;
training, by the processor, the first machine learning model using the training dataset, such that the first machine learning model is configured to receive a new network operation and predict a likelihood of the new network operation being fraudulent; and
blocking or accepting, by the processor, the new network operation using the likelihood of the new network operation being fraudulent.

2. The method of claim 1, wherein the first machine learning model is trained using a quadruplet training technique.

3. The method of claim 1, further comprising:
adding, by the processor to the training dataset, a fifth subset of the set of network operation data that includes a label indicating whether any network operation within the fifth subset of the set of network operation data is fraudulent.

4. The method of claim 1, wherein at least one network operation within the training dataset includes a lineage labeling attribute.

5. The method of claim 1, further comprising:
eliminating, by the processor from the training dataset, any network operation data with a confidence score that does not satisfy a third threshold.

6. The method of claim 1, wherein the new network operation is a pending network operation for an amount less than a price threshold.

7. The method of claim 1, wherein the first, second, third, and fourth subsets of the set of network operation data are selected further based on a similar attribute with the new network operation.

8. The method of claim 1, wherein the first machine learning model is trained using an unsupervised method and without using any labeling data associated with the training dataset.

9. A system for accelerating training time for machine learning models, the system comprising:
one or more processors configured to:
cause a second machine learning model, using a set of network operation data, to predict a likelihood indicating whether each network operation within the set of network operation data is fraudulent;
add a first subset and a second subset of the set of network operation data to a training dataset, wherein each network operation within the first subset and the second subset of the set of network operation data has a likelihood of being fraudulent by satisfying a first threshold, wherein each network operation within the first subset is associated with a first computing system of a plurality of computing systems, each network operation within the second subset is associated with any computing system of the plurality of computing systems other than the first computing system, and the first subset and the second subset of the set of network operation are not labeled for training;
add a third subset and a fourth subset of the set of network operation data to the training dataset, wherein each network operation within the third subset and the fourth subset of the set of network operation data has a likelihood of being fraudulent by satisfying a second threshold, wherein each network operation within the third subset is associated with the first computing system of the plurality of computing systems, each network operation within the fourth subset is associated with any computing system of the plurality of computing systems other than the first computing system and the third subset and the fourth subset of the set of network operation are not labeled for training;
train the first machine learning model using the training dataset, such that the first machine learning model is configured to receive a new network operation and predict a likelihood of the new network operation being fraudulent; and
block or accept the new network operation using the likelihood of the new network operation being fraudulent.

10. The system of claim 9, wherein the first machine learning model is trained using a quadruplet training technique.

11. The system of claim 9, wherein the one or more processors are further configured to:
add, to the training dataset, a fifth subset of the set of network operation data that includes a label indicating whether any network operation within the fifth subset of the set of network operation data is fraudulent.

12. The system of claim 9, wherein at least one network operation within the training dataset includes a lineage labeling attribute.

13. The system of claim 9, wherein the one or more processors are further configured to:
eliminate, from the training dataset, any network operation data with a confidence score that does not satisfy a third threshold.

14. The system of claim 9, wherein the new network operation is a pending network operation for an amount less than a price threshold.

15. The system of claim 9, wherein the first, second, third, and fourth subsets of the set of network operation data are selected further based on a similar attribute with the new network operation.

16. The system of claim 9, wherein the first machine learning model is trained using an unsupervised method and without using any labeling data associated with the training dataset.

17. A non-transitory machine-readable storage medium for accelerating training time for machine learning models, the storage medium having computer-executable instructions stored thereon that, when executed by one or more processors, cause the one or more processors to:
cause a second machine learning model, using a set of network operation data, to predict a likelihood indicating whether each network operation within the set of network operation data is fraudulent;
add a first subset and a second subset of the set of network operation data to a training dataset, wherein each network operation within the first subset and the second subset of the set of network operation data has a likelihood of being fraudulent by satisfying a first threshold, wherein each network operation within the first subset is associated with a first computing system of a plurality of computing systems, each network operation within the second subset is associated with any computing system of the plurality of computing systems other than the first computing system, and the first subset and the second subset of the set of network operation are not labeled for training;
add a third subset and a fourth subset of the set of network operation data to the training dataset, wherein each network operation within the third subset and the fourth subset of the set of network operation data has a likelihood of being fraudulent by satisfying a second threshold, wherein each network operation within the third subset is associated with the first computing system of the plurality of computing systems, each network operation within the fourth subset is associated with any computing system of the plurality of computing systems other than the first computing system and the third subset and the fourth subset of the set of network operation are not labeled for training;
train the first machine learning model using the training dataset, such that the first machine learning model is configured to receive a new network operation and predict a likelihood of the new network operation being fraudulent; and
block or accept the new network operation using the likelihood of the new network operation being fraudulent.

18. The non-transitory machine-readable storage medium of claim 17, wherein the first machine learning model is trained using a quadruplet training technique.

19. The non-transitory machine-readable storage medium of claim 17, wherein the computer-executable instructions further cause the one or more processors to:
add, to the training dataset, a fifth subset of the set of network operation data that includes a label indicating whether any network operation within the fifth subset of the set of network operation data is fraudulent.

20. The non-transitory machine-readable storage medium of claim 17, wherein the computer-executable instructions further cause the one or more processors to:
eliminate, from the training dataset, any network operation data with a confidence score that does not satisfy a third threshold.
